(19) United States
(12) Patent Application Publication
(10) Pub. No.: US 2025/0368174 A1
(43) Pub. Date: Dec. 4, 2025

(54) TWO ELECTRIC BRAKE BOOSTER MODULE VEHICLE CONTROL SYSTEM

(71) Applicant: Ford Global Technologies, LLC, Dearborn, MI (US)

(72) Inventors: Hal John Felch, Novi, MI (US); Thomas Svensson, Leichlingen (DE)

(21) Appl. No.: 18/731,164

(22) Filed: May 31, 2024

(51) Int. Cl. B60T 13/66; B60T 8/171; B60T 13/58; B60T 17/22

(52) U.S. Cl. CPC B60T 13/662; B60T 8/171; B60T 13/58; B60T 17/22; B60T 2220/04; B60T 2270/402; B60T 2270/413; B60T 2270/414

(57) ABSTRACT

A vehicle control system for a vehicle may include a first electronic brake booster module, a second electronic brake booster module, a first power supply, a second power supply, and a vehicle control module. The vehicle control module may communicate with the first electronic brake booster module and the second electronic brake booster module, and the first electronic brake booster module and the second electronic brake booster module may communicate with one another. Responsive to a fault of one of the first power supply and the second power supply, the vehicle control module, the first electronic brake booster module, or the second electronic brake booster module may coordinate selection of a remaining one of the first power supply and second power supply to individually provide power to both the first electronic brake booster module and the second electronic brake booster module to maintain brake boosting capabilities for the vehicle.

### TECHNICAL FIELD

Example embodiments generally relate to vehicle braking systems and, more particularly, relate to a system that provides redundant power for brake assemblies of different types.

### BACKGROUND

Brake boost systems are commonly used in automotive settings in order to increase the actuation force from a driver's foot on a brake pedal. For high gross weight vehicles, electronic brake boost systems are helpful to assist the hydraulic brakes of the vehicle. As such, redundancy of components within the brake boost system ensures system functionality. However, typical redundancy within brake boost systems for high gross weight vehicles can introduce inefficiency in operation, positioning, and application of the system.

Thus, it may be desirable to develop an architecture that provides redundant power supply and signaling capabilities with efficient transfers and fallbacks within a broad range of braking scenarios.

### BRIEF SUMMARY OF SOME EXAMPLES

In accordance with an example embodiment, a vehicle control system for a vehicle may be provided. The vehicle control system may include a first electronic brake booster module that may be operably coupled to a front axle hydraulic brake system, a second electronic brake booster module that may be operably coupled to a rear axle hydraulic brake system, a first power supply that may be selectively operably coupled directly to both the first electronic brake booster module and the second electronic brake booster module, a second power supply that may be selectively operably coupled directly to both the first electronic brake booster module and the second electronic brake booster module, and a vehicle control module that may be operably coupled to one of the first power supply and the second power supply. The vehicle control module may be operably coupled to a first communication channel of the first electronic brake booster module and a first communication channel of the second electronic brake booster module, and a second communication channel of the first electronic brake booster module may be operably coupled to a second communication channel of the second electronic brake booster module. Responsive to a fault of one of the first power supply and the second power supply, the vehicle control module, the first electronic brake booster module, or the second electronic brake booster module may coordinate selection of a remaining one of the first power supply and second power supply to individually provide power to both the first electronic brake booster module and the second electronic brake booster module to maintain brake boosting capabilities for the vehicle.

In another example embodiment, a vehicle control system for a vehicle may be provided. The vehicle control system may include a first electronic brake booster module that may be operably coupled to a front axle hydraulic brake system, a second electronic brake booster module that may be operably coupled to a rear axle hydraulic brake system, a first power supply that may be operably coupled directly to both the first electronic brake booster module and the second electronic brake booster module, a second power supply that may be operably coupled directly to both the first electronic brake booster module and the second electronic brake booster module, and a vehicle control module that may be operably coupled to one of the first power supply and the second power supply. The first electronic brake booster module and the second electronic brake booster module individually may further include an electronic control unit with a first circuit board and a second circuit board. The first circuit board and the second circuit board may be individually powered by a separate one of the first power supply and the second power supply. Responsive to a fault of one of the first power supply and second power supply, the vehicle control module, the first electronic brake booster module, or the second electronic brake booster module may coordinate a remaining one of the first power supply and second power supply to individually provide power to both the first circuit board and the second circuit board of each of the first electronic brake booster module and the second electronic brake booster module to maintain brake boosting capabilities for the vehicle.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a block diagram of a vehicle control system in accordance with an example embodiment;

FIG. 2 illustrates a block diagram of some components of the vehicle control system of FIG. 1 in accordance with an example embodiment; and

FIG. 3 illustrates a block diagram highlighting the power components of the vehicle control system of FIG. 1 in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Normally, the redundancy for a pure hydraulic brake system is provided through mechanical hydraulic push through of a brake pedal on a hydraulic cylinder supplying braking pressure to all four wheel ends. In some situations and vehicle architectures, the front brakes and rear brakes are separated circuits with separate electronic brake booster (EBB) modules employed to deliver additional braking torque. Front and rear axle EBB hydraulic architectures in passenger vehicles require a redundant power supply and a supporting control structure. However, as noted above, doing so in a context in which different brake systems are employed may be difficult to achieve, and signaling in backup modes of operation may be difficult to achieve as well. Typically, redundancy within high gross weight vehicles would require three brake control modules (2 EBB modules with an ESC module, for instance) with separate power supplies. These three separate brake control modules require difficult assembly and complex wiring to install. Example embodiments aim to provide separate power supplies transferring power to only two separate EBB modules simultaneously, and where a single one of the separate power supplies may transfer enough power to both EBB modules to ensure brake boosting capabilities by itself.

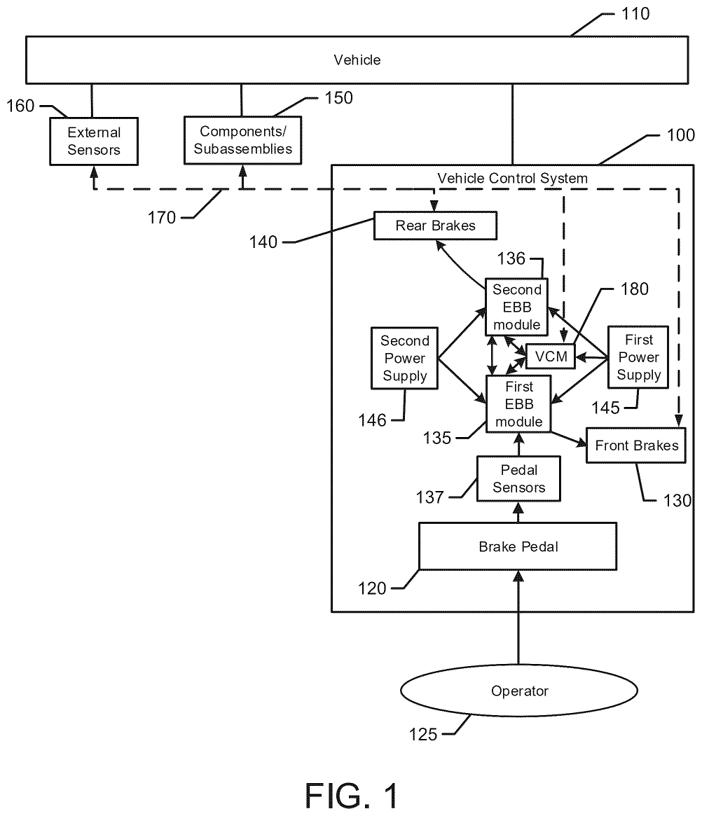

FIG. 1 illustrates a block diagram of a vehicle control system 100 of an example embodiment. The components of the vehicle control system 100 may be incorporated into a vehicle 110 (e.g., via being operably coupled to a chassis of the vehicle 110, various components of the vehicle 110 and/or electronic control systems of the vehicle 110). Of note, although the components of FIG. 1 may be operably coupled to the vehicle 110, it should be appreciated that such connection may be either direct or indirect. Moreover, some of the components of the vehicle control system 100 may be connected to the vehicle 110 via intermediate connections to other components either of the chassis or of other electronic and/or mechanical systems or components. In some cases, the chassis may include or be defined by a frame, and the frame may additionally be formed of one or more casted subframes.

The vehicle control system 100 may include one or more input devices in the form of one or more control pedals. In some embodiments, the control pedals may include a brake pedal 120 that is generally foot operated by an operator 125 to initiate braking forces, or braking torque application at the wheels of the vehicle 110. The brake pedal 120 may be operably coupled to front brakes 130 via mechanical coupling under control of a first EBB module 135. In an example embodiment, the front brakes 130 may be hydraulic brakes, and the brake pedal 120 may be hydraulically coupled to the front brakes 130. The brake pedal 120 may also be operably coupled to rear brakes 140 via mechanical coupling and communication transfers under control of a second EBB module 136. In some cases, the rear brakes 140 may be hydraulic brakes, and the brake pedal 120 may be hydraulically coupled to the rear brakes 140. The front brakes 130 and the rear brakes 140 may be operably coupled to pedal sensor 137. In some cases, the pedal sensors 137 may include a pedal travel sensor to receive position information indicative of the brake pedal 120 and a pedal angle sensor to receive angle measurements of the brake pedal 120. The pedal travel sensor may provide data indicative of the precise actuation of the brake pedal 120, and the pedal angle sensor may provide data indicative of the precise angle of the brake pedal 120. In an example embodiment, the data provided by the pedal travel sensor and the pedal angle sensor may be provided as inputs to the first EBB module 135 and/or the second EBB module 136. In some cases, the data associated with the pedal travel sensor and the pedal angle sensor may be provided as inputs to other vehicle control modules directly or to other vehicle control modules through the first EBB module 135, the second EBB module 136, or various connectors.

Notably, the control pedals could alternatively be hand operated or any other operable member via which the operator 125 may provide an input indicative of an intent of the operator 125 relative to controlling net torque for application to the wheels of the vehicle 110. In some cases, the vehicle control system 100 may be configured to perform other tasks related or not related to propulsive and braking control or performance management.

In an example embodiment, the control system 100 may receive information that is used to determine vehicle status from various components or subassemblies 150 of the vehicle 110. Additionally or alternatively, various sensors that may be operably coupled to the components or subassemblies 150 may be included and may provide input to the control system 100 that is used in determining vehicle status. Such sensors may be part of a sensor network 160 and sensors of the sensor network 160 may be operably coupled to the control system 100 (and/or the components or subassemblies 150) via one or more instances of a vehicle communication bus (e.g., a controller area network (CAN) bus) 170.

In some cases, the vehicle control system 100 may include a vehicle control module (VCM) 180 outside of the first EBB module 135 and the second EBB module 136. The VCM 180 may communicate with the sensor network 160, the components or subassemblies 150, as well as various vehicle control system 100 components. In an example embodiment, the VCM 180 may operate as a fallback if the first EBB module 135 and/or the second EBB module 136 experiences a fault. In some cases, the fallback may be the VCM 180 fully or partially controlling the front brakes 130 and the rear brakes 140 of the vehicle 110.

The components or subassemblies 150 may include, for example, a braking system, a propulsion system and/or a wheel assembly of the vehicle 110. The braking system may be configured to provide braking inputs to braking components of the vehicle 110, and includes the components discussed above. One or more corresponding sensors of the sensor network 160 that may be operably coupled to the brake system and/or the wheel assembly may provide information relating to brake torque, brake torque rate, vehicle velocity (including rate of change of velocity), front/rear wheel speeds, vehicle pitch, etc. Inputs from the sensors of the sensor network 160 may be provided to the vehicle control system 100 to enable the vehicle control system 100 to provide various primary and secondary (or backup) control functions related to the components or subassemblies 150. Accordingly, for example, the vehicle control system 100 may be able to receive numerous different parameters, indications and other information that may be related to or indicative of different situations or conditions associated with vehicle status. The vehicle control system 100 may also receive information indicative of the intent of the operator 125 relative to control of various aspects of operation of the vehicle 110 and then be configured to use the information received to provide instructions to control responses to the situations or conditions determined.

In some cases, the first EBB module 135 and the second EBB module 136 may be powered by a first power supply 145 and a second power supply 146. The first power supply 145 and the second power supply 146 may be operably coupled to the first EBB module 135 and the second EBB module 136 directly or through the various connectors. The first power supply 145 and the second power supply 146 may be a variety of different power sources, such as but not limited to various types of batteries. In an example embodiment, the first power supply 145 and the second power supply 146 may power components of the vehicle control system 100 other than the first EBB module 135 and the second EBB module 136, including but not limited to components of the sensor network 160 and the VCM 180.

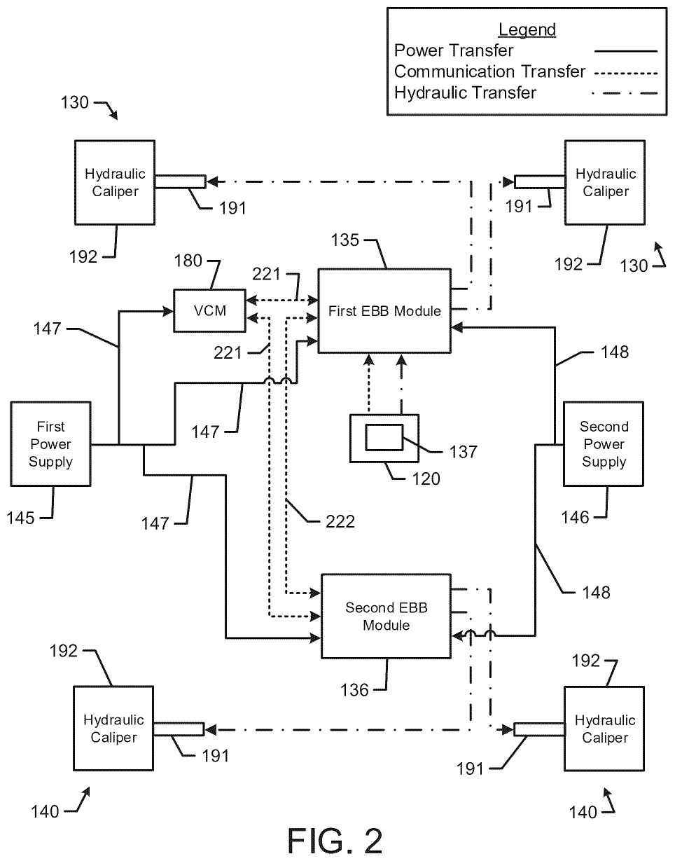

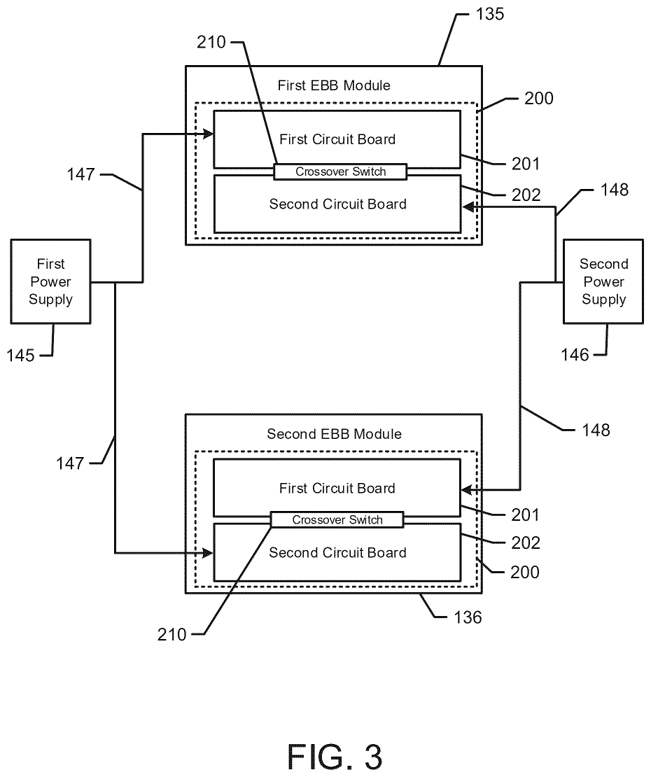

FIGS. 2 and 3 illustrates a block diagram of various components of the vehicle control system, which may be considered either a specific example of the vehicle control system 100 of FIG. 1, or a portion thereof that is associated with a vehicle braking system. FIG. 2 additionally displays the operable coupling and transfers between various components of the vehicle control system 100 in accordance with an example embodiment. Three different types of operable coupling or transfers are highlighted in the figure, including power supply transfer (solid line), communication information transfer (dotted line), and hydraulic transfer (dashed and single dotted line). In some cases, the hydraulic transfer may be performed via valves operably coupled to the first and/or second EBB modules 135 and 136 and the brake pedal 120 that may control the supply of hydraulic fluid to the jounce hoses 191 operably coupled to the hydraulic calipers 192 of both the front brakes 130 and the rear brakes 140.

In some cases, the first EBB module 135 and the second EBB module 136 may each include an electronic control unit (ECU) 200. The ECU 200 of the first EBB module 135 and the second EBB module 136 may control the aspects of the braking system via receiving input data from a variety of sensors (including the pedal sensors 137) and processing the input data to determine an adjustment, actuation, or modification of specific brakes of the braking system. For example, the ECU 200 may process the precise actuation data from the pedal travel sensor and the pedal angle data from the pedal angle sensor to determine the amount of brake boosting to provide to the front hydraulic brakes. In some cases, the ECU 200 may be formed integrally with the first EBB module 135 or the second EBB module 136 and may not be a separate unit.

In an example embodiment, the ECU 200 may perform the processing with one or more microcontrollers. The one or more microcontrollers may include an actuation microcontroller and a modulation microcontroller. The one or more microcontrollers may include processing circuitry that includes a processor and memory. The processing circuitry may be configured to provide electronic control of the inputs to one or more functional units of the vehicle control system 100 and to process data received at or generated by the one or more functional units of the vehicle control system. Thus, the processing circuitry may be configured to perform data processing, control function execution and/or other processing and management services according to an example embodiment. In some embodiments, the processing circuitry may be embodied as a chip or chip set. In other words, the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry may therefore, in some cases, be configured to implement an embodiment of the present invention on a single chip or as a single “system on a chip.” As such, in some cases, a chip or chipset may constitute means for performing one or more operations for providing the functionalities described herein. In an example embodiment, other vehicle control modules (including the VCM 180) may include similar processing circuitry.

In some cases, the ECU 200 may include one or more circuit boards to operably couple and/or wire various necessary electronic components together to enable the first EBB module 135 and the second EBB module 136 functionality. In an example embodiment, the ECU 200 may include multiple circuit boards that each have a different planned functionality. For example, in some cases, the ECU 200 may have a first circuit board 201 to control brake actuation and a second circuit board 202 to control brake modulation. The first circuit board 201 may include the actuation microcontroller, and the second circuit board 202 may include the modulation microcontroller.

In an example embodiment, the first EBB module 135 and the second EBB module 136 may share the same structure. In some cases, the first EBB module 135 and second EBB module 136 may have different structures. For instance, both the first EBB module 135 and the second EBB module 136 may have a first circuit board 201 to control brake actuation and a second circuit board 202 to control brake modulation. However, in some cases for the first EBB module 135, its first circuit board 201 may be operably coupled to the first power supply 145 and its second circuit board 202 may be operably coupled to the second power supply 146. The second EBB module 136 though may have its first circuit board 201 operably coupled to the second power supply 146 and its first circuit board 201 operably coupled to the first power supply 145.

In an example embodiment, the first power supply 145 may provide power to the first EBB module 135 and the second EBB module 136 via respective ECU headers and respective first power lines 147, and the second power supply 146 may provide power to the first EBB module 135 and the second EBB module 136 via respective ECU headers and respective second power lines 148. In an example embodiment, the first and second power supplies 145 and 146 may directly operably couple to the respective ECU 200 of the first EBB module 135 and the second EBB module 136 without utilizing an ECU header. In some cases, the first power supply 145 and the second power supply 146 may provide power to other components, sensors, or devices within the vehicle control system 100 besides a respective ECU 200.

In an example embodiment, the first power line 147 and the second power line 148 may operably couple to respective current sinks on the first circuit boards 201 and second circuit boards 202 of the first EBB module 135 and the second EBB module 136. In some cases, each respective current sink may further be operably coupled to a respective ground line via a respective ground terminal. The ground line and ground terminal may help ground the power transfer from the power supplies to the respective ECUs in case of a short circuit.

The first power line 147 and the second power line 148 may further transfer power to one or more reverse current protection (RCP) subsystems. The one or more RCP subsystems may allow the first EBB module 135 and the second EBB module 136 to help prevent current flow in the wrong direction causing additional faults. The one or more RCP subsystems may test or evaluate specific sensors or components within the ECU 200 to ensure the sensors or components are functioning properly and efficiently. In some cases, the first circuit boards 201 and the second circuit boards 202 of the first EBB module 135 and the second EBB module 136 may include separate ones of the one or more RCP subsystems. For example, the first circuit board 201 may include an actuation RCP subsystem and the second circuit board 202 may include a modulation RCP subsystem. For instance, in some cases for the first EBB module 135, the actuation RCP subsystem may support the pedal travel sensor to ensure accurate data is being received. The actuation RCP subsystem and the modulation RCP subsystem may support any number of sensors and components of the first EBB module 135, the second EBB module 136, or the vehicle control system 100, such as but not limited to the pedal sensor 137, outputs of the one or more microcontrollers, actuator valves, and/or modulator valves. In some cases, the actuation RCP subsystem and the modulation RCP subsystem may support the operational status of one or more of the first power supply 145 and the second power supply 146.

In an example embodiment, the actuator valves may be valves that control the opening and closing of hydraulic fluid flow to the front brakes 130 or the rear brakes 140. The modulator valves may control the specific rate of hydraulic fluid flow to the front brakes 130 or the rear brakes 140 based on determinations by the modulation microcontroller of the respective EBB module. In some cases, the modulation microcontroller and the modulation RCP subsystem may be operably coupled via diode field-effect transistor (FET) controller to help control current or voltage flow between the modulation microcontroller and the modulation RCP subsystem. In an example embodiment, the diode FET controller may ensure that there is stable communication between the modulation microcontroller and the modulation RCP subsystem by ensuring the current is strong enough for stable communication by amplifying the initial current.

In some cases, the first EBB module 135 and the second EBB module 136 may each include a respective instance of a crossover switch 210. The crossover switch 210 may allow the transfer of power from either one of the first circuit board 201 or the second circuit board 202 of the ECU 200 of the first EBB module 135 or the second EBB module 136 to the other circuit board in case of power supply faults. The crossover switch 210 may be operably coupled and in communication with the one or more RCP subsystems and the one or more microcontrollers. In an example embodiment, the one or more microcontrollers may determine the operational status of the first power supply 145 and/or the second power supply 146 and communicate the determined operational status to the crossover switch 210. In some cases, the first EBB module 135 and the second EBB module 136 may determine the operational status without input from the VCM 180 via the one or more microcontrollers. The one or more microcontrollers of the first EBB module 135 and the second EBB module 136 may additionally adjust the front brakes 130 and the rear brakes 140 with or without input from the VCM 180.

In some cases, the operational status of the first power supply 145 or the second power supply 146 may indicate the degree of functionality of the respective power supply. For example, the operational status of the power supply may be determined or classified to be one of fully functioning, partially functioning, or experiencing a no power. The classification of the operational status of the power supply may be supported by the one or more RCP subsystems and/or the one or more microcontrollers.

In an example embodiment, the crossover switch 210 may receive indications that the operational status of both power supplies are fully functional, and thus not transfer power between either circuit board of the first EBB module 135 or second EBB module 136. In some cases, responsive to a determination that the operational status of one of the first power supply 145 or the second power supply 146 are partially functioning, a fault state for the first EBB module 135 and the second EBB module 136 may be determined to be a single power supply fault. Responsive to determining the EBB modules are experiencing a fault state, a fallback condition may be determined and executed by EBB modules. In some cases, the fallback condition may be determined by the one or more microcontrollers, but the fallback condition determination is not limited to the microcontrollers and may be determined by other component of the first EBB module 135, the second EBB module 136, or the vehicle control system 100.

In an example embodiment, the first EBB module 135 and the second EBB module 136 may communicate via a variety of communication links. In some cases, the first EBB module 135 and second EBB module 136 may communicate directly with the VCM 180. For example, a first communication channel 221 of the first EBB module 135 and the first communication channel 221 of the second EBB module 136 may communicate directly with the VCM 180. In an example embodiment, the first communication channel 221 may be a public communication channel. In some cases, the first communication channel 221 may be a public controller area network (CAN) connection. However, the first communication channel 221 may not be limited to a public CAN connection and may be any number of communication methods including but not limited to private CAN connections, wireless connections, or any other communication method that does not limit the information transfer via the first communication channel 221.

In an example embodiment, the first EBB module 135 and the second EBB module 136 may each include a second communication channel 222. In some cases, the second communication channel 222 of the first EBB module 135 and the second communication channel 222 of the second EBB module 136 may directly communicate with one another. In some cases, the second communication channel 222 may be a private CAN connection. The private CAN connection may limit the access of transferring information via the second communication channel 222 to only the first EBB module 135 and the second EBB module 136. However, the second communication channel 222 may not be limited to a private CAN connection and may be any number of communication methods including but not limited to public CAN connections, wireless connections, or any other communication method that does not limit the information transfer via the second communication channel 222. In some cases, the second communication channel of the first EBB module 135 and the second EBB module 136 may be between the one or more microcontrollers of the respective EBB modules.

In an example embodiment, the brake pedal 120 and the pedal sensors 137 may only be operably coupled to the first EBB module 135. For example, the second EBB module 136 may only receive input data from the brake pedal 120 and the pedal sensors 137 via the second communication channel 222 between the first EBB module 135 and the second EBB module 136. In some cases, the brake pedal 120 and pedal sensor 137 may be operable coupled to the first EBB module 135 hydraulically and communicatively. In an example embodiment, the brake pedal 120 and pedal sensors 137 may ground the first EBB module 135. In some cases, the brake pedal 120 and pedal sensors 137 may be operably coupled to each individual brake of the front brakes 130 and the rear brakes 140 directly.

In an example embodiment, responsive to the fault state being determined to be the single power supply fault, the crossover switch 210 may transfer power to one or more of the first circuit board 201 or the second circuit board 202 that is experiencing the single power supply fault from the remaining one or more of the first circuit board 201 or the second circuit board 202 not experiencing the single power supply fault. In some cases, the crossover switch 210 may include two internal crossover switches to transition power between the circuit boards. For example, the crossover switch 210 may include an actuation crossover switch and a modulation crossover switch. In an example embodiment, responsive to the first circuit board 201 of the first EBB module 135 experiencing a single power supply fault of the first power supply 145, the modulation crossover switch of the first EBB module 135 may transfer power or voltage from the second circuit board 202 (powered by the second power supply 146) to the first circuit board 201. The power may be transferred directly to the actuation microcontroller of the first EBB module 135 to ensure functionality. In some cases, the alternative may occur where responsive to the second circuit board 202 of the first EBB module 135 experiencing a single power supply fault of the second power supply 146, the actuation crossover switch may transfer power or voltage from the first circuit board 201 (powered by the first power supply 145) to the second circuit board 202. The power may be transferred directly to the modulation microcontroller to ensure functionality. In some cases, the alternative of the previous example may be seen with the second EBB module 136, as the first circuit board 201 of the second EBB module 136 may be powered by the second power supply 146 and second circuit board 202 of the second EBB module 136 may be powered by the first power supply 145 (opposite configuration than the first EBB module 135).

In an example embodiment, responsive to a determination that the operational status of both the first power supply 145 and the second power supply 146 indicates that each is experiencing a power supply fault (partially functioning or experiencing no power), a fault state for the first EBB module 135 and the second EBB module 136 may be determined to be a double power supply fault. A double power supply fault may be determined via the complete loss of communication with components of both circuit boards of the respective EBB modules. In some cases, the double power supply fault may be determined via the one or more RCP subsystem support of components. In an example embodiment, a private communication link between internal EBB components may determine the double power supply fault via loss of function of specific components. For example, a respective microcontroller of each circuit board within one of the first EBB module 135 and the second EBB module 136 may communicate privately with one another to confirm component status to assist with classification of the operational status and determination of the fault state.

In some cases, responsive to determining the fault state to be the double power supply fault, the VCM 180 or the vehicle control system 100 itself (other control modules or inherent structure) may be configured to execute the fallback condition to have the front brakes 130 and the rear brakes 140 operate according to a hydraulic brake fallback. In an example embodiment, the hydraulic brake fallback may revert the front brakes 130 and the rear brakes 140 to purely mechanical brake actuation and modulation via the brake pedal 120. For example, the operator 125 pressing the brake pedal 120 may provide hydraulic fluid into the brake calipers of the front brakes 130. In this regard, the fallback condition responsive to determining the fault state to be the double power supply fault may not rely upon the first EBB module 135 or the second EBB module 136, and the front brakes 130 and the rear brakes 140 may operate unboosted via traditional hydraulic brake functionality.

In an example embodiment, the ECU 200 may be operably coupled to a separate hydraulic control unit (HCU) via a motor. In some cases, the HCU may include various valves (e.g. actuator valves and modulator valves), sensors (e.g. pedal travel sensor and the pedal angle sensor), and components from the first and second EBB modules 135 and 136.

In some cases, the first EBB module 135 and the second EBB module 136 may be contained within a single enclosed box, housing or container for convenience in assembly via the reduction of individual components. In an example embodiment, the first power supply 145 and the second power supply 146 may be ASIL B rated. ASIL B rating is a consensus rating aimed to set a baseline for power supply to important automotive sensors. ASIL B rating limits the number of faults experienced by the power supply to 100 faults in one billion hours of operation. Given the ASIL B rating of an individual power supply and the redundancy of the multiple power supplies, in some cases, the vehicle control system may overall have a rating of ASIL D (or 10 faults in one billion hours of operation). In some cases, both the first power supply 145 and the second power supply 146 may not need to be ASIL B rated. For example, if only one power supply is ASIL B rated and the other power supply is merely quality method (QM) rated (one level below ASIL A), the overall vehicle control system may still have an overall ASIL D rating.

Thus, a vehicle control system for a vehicle may be provided. The vehicle control system may include a first electronic brake booster module that may be operably coupled to a front axle hydraulic brake system, a second electronic brake booster module that may be operably coupled to a rear axle hydraulic brake system, a first power supply that may be selectively operably coupled directly to both the first electronic brake boost module and the second electronic brake boost module, a second power supply that may be selectively operably coupled directly to both the first electronic brake boost module and the second electronic brake boost module, and a vehicle control module that may be operably coupled to one of the first power supply and the second power supply. The vehicle control module may be operably coupled to a first communication channel of the first electronic brake booster module and a first communication channel of the second electronic brake booster module, and a second communication channel of the first electronic brake booster module may be operably coupled to a second communication channel of the second electronic brake booster module. Responsive to a fault of one of the first power supply and the second power supply, the vehicle control module, the first electronic brake booster module, or the second electronic brake booster module may coordinate selection of a remaining one of the first power supply and second power supply to individually provide power to both the first electronic brake booster module and the second electronic brake booster module to maintain brake boosting capabilities for the vehicle.

The system of some embodiments may include additional features, modifications, augmentations and/or the like to achieve further objectives or enhance performance of the system. The additional features, modifications, augmentations and/or the like may be added in any combination with each other. Below is a list of various additional features, modifications, and augmentations that can each be added individually or in any combination with each other. For example, the first communication channel of the first electronic brake booster and the first communication channel of the second electronic brake booster module may be public control area network channels, and the second communication channel of the first electronic brake booster and the second communication channel of the second electronic brake booster module may be private control area network channels. In an example embodiment, a first operator pedal may be operably coupled to the first electronic brake booster module, and inputs of the first operator pedal may be transmitted to the second communication channel of the second electronic brake booster module via the second communication channel of the first electronic brake booster. In some cases, the first electronic brake booster module and the second electronic brake booster module may adjust the front hydraulic brake system and the rear hydraulic brake system without input from the vehicle control module. In an example embodiment, the first electronic brake booster module may include a first microcontroller and the second electronic brake booster module may include a second microcontroller. The first microcontroller and the second microcontroller may communicate with one another via the second communication channel of the first electronic brake booster module and the second communication channel of the second electronic brake booster module. In an example embodiment, the fault of the one of the first power supply or the second power supply may be determined based on a classification of an operational status of the one of the first power supply or the second power supply. In some cases, the classification of the operational status may be performed by the first electronic brake booster module and the second electronic brake booster module, and the classification of the operational status may be one of fully functioning, partially functioning, or no power. In an example embodiment, responsive the fault of both the first power supply and the second power supply, the front axle hydraulic brake system and the rear axle hydraulic brake system may operate unboosted via traditional hydraulic brake functionality. In some cases, the first electronic brake booster module may be grounded via the brake pedal. In an example embodiment, the first power supply and the second power supply may provide power to other vehicle components other than the vehicle control module, the first electronic brake booster module, or the second electronic brake booster module. In some cases, the first electronic brake booster module and the second electronic brake booster module may each include a crossover switch between a first circuit board and a second circuit board. The first circuit board may control brake actuation and the second circuit board may control brake modulation. In an example embodiment, the first circuit board of the first electronic brake booster module may be powered by the first power supply and the second circuit board of the first electronic brake booster module may be powered by the second power supply. The first circuit board of the second electronic brake booster module may be powered by the second power supply, and the second circuit board of the second electronic brake booster module may be powered by the first power supply. In some cases, responsive to the fault in the first power supply, the crossover switch of the first electronic brake booster module may transfer power from the second circuit board to the first circuit board, and the crossover switch of the second electronic brake booster module may transfer power from the first circuit board to the second circuit board. In an example embodiment, wherein responsive to the fault in the second power supply, the crossover switch of the first electronic brake booster module may transfer power from the first circuit board to the second circuit board, and the crossover switch of the second electronic brake booster module may transfer power from the second circuit board to the first circuit board.

In another example embodiment, a vehicle control system for a vehicle may therefore be provided. The vehicle control system may include a first electronic brake booster module that may be operably coupled to a front axle hydraulic brake system, a second electronic brake booster module that may be operably coupled to a rear axle hydraulic brake system, a first power supply that may be operably coupled directly to both the first electronic brake booster module and the second electronic brake booster module, a second power supply that may be operably coupled directly to both the first electronic brake booster module and the second electronic brake booster module, and a vehicle control module that may be operably coupled to one of the first power supply and the second power supply. The first electronic brake booster module and the second electronic brake booster module individually may further include an electronic control unit with a first circuit board and a second circuit board. The first circuit board and the second circuit board may be individually powered by a separate one of the first power supply and the second power supply. Responsive to a fault of one of the first power supply and second power supply, the vehicle control module, the first electronic brake booster module, or the second electronic brake booster module may coordinate a remaining one of the first power supply and second power supply to individually provide power to both the first circuit board and the second circuit board of each of the first electronic brake booster module and the second electronic brake booster module to maintain brake boosting capabilities for the vehicle.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A vehicle control system for a vehicle comprising:
a first electronic brake booster module operably coupled to a front axle hydraulic brake system;
a second electronic brake booster module operably coupled to a rear axle hydraulic brake system;
a first power supply selectively operably coupled to both the first electronic brake boost module and the second electronic brake booster module;
a second power supply selectively operably coupled to both the first electronic brake booster module and the second electronic brake boost module; and
a vehicle control module operably coupled to one of the first power supply and the second power supply,
wherein the vehicle control module is operably coupled to a first communication channel of the first electronic brake booster module and a first communication channel of the second electronic brake booster module,
wherein a second communication channel of the first electronic brake booster module is operably coupled to a second communication channel of the second electronic brake booster module, and
wherein, responsive to a fault of one of the first power supply and the second power supply, the vehicle control module, the first electronic brake booster module, or the second electronic brake booster module coordinates selection of a remaining one of the first power supply and second power supply to individually provide power to both the first electronic brake booster module and the second electronic brake booster module to maintain brake boosting capabilities for the vehicle.

2. The vehicle control system of claim 1, wherein the first communication channel of the first electronic brake booster module and the first communication channel of the second electronic brake booster module are public control area network channels, and
wherein the second communication channel of the first electronic brake booster module and the second communication channel of the second electronic brake booster module are private control area network channels.

3. The vehicle control system of claim 1, wherein a first operator pedal is operably coupled to the first electronic brake booster module, and
wherein inputs of the first operator pedal are transmitted to the second communication channel of the second electronic brake booster module via the second communication channel of the first electronic brake booster module.

4. The vehicle control system of claim 1, wherein the first electronic brake booster module and the second electronic brake booster module adjust the front hydraulic brake system and the rear hydraulic brake system without input from the vehicle control module.

5. The vehicle control system of claim 1, wherein the first electronic brake booster module further comprises a first microcontroller and the second electronic brake booster module further compresses a second microcontroller, and
wherein the first microcontroller and the second microcontroller communicate with one another via the second communication channel of the first electronic brake booster module and the second communication channel of the second electronic brake booster module.

6. The vehicle control system of claim 1, wherein the fault of the one of the first power supply or the second power supply is determined based on a classification of an operational status of the one of the first power supply or the second power supply.

7. The vehicle control system of claim 6, wherein the classification of the operational status is performed by the first electronic brake booster module and the second electronic brake booster module, and
wherein the classification of the operational status is one of fully functioning, partially functioning, or no power.

8. The vehicle control system of claim 1, wherein responsive the fault of both the first power supply and the second power supply, the front axle hydraulic brake system and the rear axle hydraulic brake system operate unboosted via traditional hydraulic brake functionality.

9. The vehicle control system of claim 1, wherein the first electronic brake booster module is grounded via the brake pedal.

10. The vehicle control system of claim 1, wherein the first power supply and the second power supply provide power to other vehicle components other than the vehicle control module, the first electronic brake booster module, or the second electronic brake booster module.

11. The vehicle control system of claim 1, wherein the first electronic brake booster module and the second electronic brake booster module each comprise a crossover switch between a first circuit board and a second circuit board,
wherein the first circuit board controls brake actuation and the second circuit board controls brake modulation.

12. The vehicle control system of claim 11, wherein the first circuit board of the first electronic brake booster module is powered by the first power supply and the second circuit board of the first electronic brake booster module is powered by the second power supply, and
wherein the first circuit board of the second electronic brake booster module is powered by the second power supply and the second circuit board of the second electronic brake booster module is powered by the first power supply.

13. The vehicle control system of claim 12, wherein responsive to the fault in the first power supply, the crossover switch of the first electronic brake booster module transfers power from the second circuit board to the first circuit board, and the crossover switch of the second electronic brake booster module transfers power from the first circuit board to the second circuit board.

14. The vehicle control system of claim 12, wherein responsive to the fault in the second power supply, the crossover switch of the first electronic brake booster module transfers power from the first circuit board to the second circuit board, and the crossover switch of the second electronic brake booster module transfers power from the second circuit board to the first circuit board.

15. A vehicle control system for a vehicle comprising:
a first electronic brake booster module operably coupled to a front axle hydraulic brake system;
a second electronic brake booster module operably coupled to a rear axle hydraulic brake system;
a first power supply operably coupled directly to both the first electronic brake booster module and the second electronic brake booster module;
a second power supply operably coupled directly to both the first electronic brake booster module and the second electronic brake booster module; and
a vehicle control module operably coupled to one of the first power supply and the second power supply,
wherein the first electronic brake booster module and the second electronic brake booster module individually further comprise an electronic control unit with a first circuit board and a second circuit board,
wherein the first circuit board and the second circuit board are individually powered by a separate one of the first power supply and the second power supply,
wherein, responsive to a fault of one of the first power supply and second power supply, the vehicle control module, the first electronic brake booster module, or the second electronic brake booster module coordinates a remaining one of the first power supply and second power supply to individually provide power to both the first circuit board and the second circuit board of each of the first electronic brake booster module and the second electronic brake booster module to maintain brake boosting capabilities for the vehicle.

16. The vehicle control system of claim 15, wherein the first electronic brake booster module and the second electronic brake booster module each comprise a crossover switch between the first circuit board and the second circuit board,
wherein the first circuit board controls brake actuation and the second circuit board controls brake modulation.

17. The vehicle control system of claim 16, wherein the first circuit board of the first electronic brake booster module is powered by the first power supply and the second circuit board of the first electronic brake booster module is powered by the second power supply, and
wherein the first circuit board of the second electronic brake booster module is powered by the second power supply and the second circuit board of the second electronic brake booster module is powered by the first power supply.

18. The vehicle control system of claim 17, wherein responsive to the fault in the first power supply, the crossover switch of the first electronic brake booster module transfers power from the second circuit board to the first circuit board, and the crossover switch of the second electronic brake booster module transfers power from the first circuit board to the second circuit board.

19. The vehicle control system of claim 17, wherein responsive to the fault in the second power supply, the crossover switch of the first electronic brake booster module transfers power from the first circuit board to the second circuit board, and the crossover switch of the second electronic brake booster module transfers power from the second circuit board to the first circuit board.

20. The vehicle control system of claim 15, wherein the fault of the one of the first power supply or the second power supply is determined based on a classification of an operational status of the one of the first power supply or the second power supply,
wherein the classification of the operational status is performed by the first electronic brake booster module and the second electronic brake booster module, and
wherein the classification of the operational status is one of fully functioning, partially functioning, or no power.
